(19) United States
(12) Patent Application Publication
(10) Pub. No.: US 2021/0336498 A1
(43) Pub. Date: Oct. 28, 2021

(54) ROTOR AND MACHINE WITH A SUPERCONDUCTING PERMANENT MAGNET IN A ROTOR CARRIER

(71) Applicant: Rolls-Royce Deutschland Ltd & Co KG, Blankenfelde-Mahlow (DE)

(72) Inventor: Peter Kummeth, Herzogenaurach (DE)

(21) Appl. No.: 17/286,864

(22) PCT Filed: Oct. 11, 2019
(86) PCT No.: PCT/EP2019/077649

§ 371 Date: Apr. 20, 2021

(30) Foreign Application Priority Data
Oct. 22, 2018 (DE) 102018217983.2

(51) Int. Cl. H02K 1/28; H02K 3/493; H02K 9/22; H02K 3/34; H02K 3/52; H02K 55/04

(52) U.S. Cl. CPC H02K 1/28; H02K 3/493; H02K 9/22; H02K 2213/03; H02K 3/527; H02K 55/04; H02K 3/345

(57) ABSTRACT

A rotor for an electric machine having a central rotor axis is disclosed herein. The rotor includes a rotor carrier and at least one permanent-magnetic, superconducting magnet device mechanically supported by the rotor carrier and having one or more superconducting magnet elements. The respective superconducting magnet element is embedded in an appropriate, assigned radially outer recess of the rotor carrier. The respective superconducting magnet element is formed by at least one strip conductor stack made up of multiple superconducting strip conductors. The respective strip conductor stack is secured in the associated recess by a radially further outer pole cap such that the pole cap holds together the individual strip conductors in the strip conductor stack. An electric machine including a rotor of this type and a method for producing a rotor of this type is also disclosed.

The present patent document is a § 371 nationalization of PCT Application Serial No. PCT/EP2019/077649, filed Oct. 11, 2019, designating the United States, which is hereby incorporated by reference, and this patent document also claims the benefit of German Patent Application No. 10 2018 217 983.2, filed Oct. 22, 2018, which is also hereby incorporated by reference.

### TECHNICAL FIELD

The present disclosure relates to a rotor for an electrical machine with a central rotor axis, including a rotor support and at least one superconducting permanent magnet device which is mechanically supported by the rotor support and has one or more superconducting magnet elements. The disclosure furthermore relates to an electrical machine having such a rotor and to a method for producing such a rotor.

### BACKGROUND

The prior art discloses electrical machines which have a stator and a rotor and in which the rotor is designed to generate an electromagnetic excitation field. Such an excitation field may be generated either by permanent magnets arranged on the rotor or by coil elements arranged on the rotor. Rotors with superconducting coil elements are sometimes used for electrical machines with particularly high power densities. Another possible way of achieving particularly high power densities is the use of superconducting permanent magnets.

The power density of an electrical machine scales with the magnetic flux density that may be generated by the electromagnets or permanent magnets used in the electrical machine. This relationship allows a significant increase in the power density without a significant change in the topology of the electrical machine if, for example, conventional permanent magnets are replaced by superconducting permanent magnets, because higher magnetic flux densities may be generated with these.

One approach to increasing the power density is therefore to equip an electrical machine with permanent magnets composed of superconducting materials. At correspondingly low temperatures, materials of this kind may generate magnetic flux densities in orders of magnitude that are a multiple of the flux densities that may be generated with conventional permanent magnets. For example, it is possible to use a magnet composed of YBCO (yttrium-barium-copper oxide) at approx. 30 K to generate a magnetic field with a magnetic flux density of up to 8 T, while a conventional magnet, (e.g., including NeFeB), generates flux densities in orders of magnitude of approx. 1.2 T.

German Patent Publication DE102016205216A1 describes an electrical machine having superconducting permanent magnets and also a method for magnetizing the permanent magnets. Before being operated, superconducting permanent magnets first have to be magnetized at a cryogenic temperature below the transition temperature of the superconductor and then permanently kept at such a cryogenic temperature. A permanent magnetization state is achieved owing to the loss-free flow of current in the superconductor material.

On account of the high critical current densities and the high critical magnetic flux densities of the superconducting materials that are now available, electrical machines with a fundamentally very high useful magnetic flux (e.g., the usable magnetic flux in the air gap of the electrical machine) may be achieved in this way. For radial flux machines with superconducting permanent magnets in the rotor, only very few actual technical implementations are known to date. Most of the known concepts are based on replacing the conventional permanent magnets with superconducting permanent magnet elements in the rotor of a conventional radial flux machine. This means that, in the rotor, a plurality of superconducting magnet elements are then distributed over the circumference of the rotor in a radially external region of a rotor support. In this way, a p pole magnetic field may be generated by the rotor, the number p of magnetic poles corresponding either directly to the number of superconducting permanent magnet elements distributed over the circumference or to the number of groups of superconducting magnet elements that are respectively combined to form a pole.

According to the prior art, the individual superconducting magnet elements may fundamentally be designed either as a stack composed of a plurality of superconducting strip conductors or as superconducting bulk elements. The design of the magnet elements as a strip conductor stack has proven to be advantageous in order to produce superconducting magnet elements with comparatively large dimensions and a generally relatively freely selectable size and geometry. In addition, the amount of superconductor material required is relatively low in comparison with the superconducting bulk elements.

The disadvantage of the known permanently excited rotors having superconducting strip conductor stacks is that the production of the individual superconducting magnet elements is comparatively complex and requires additional production devices. The individual strip conductor stacks according to the prior art may be used as prefabricated components which are manufactured in a separate production process before being arranged in the rotor support. During the production of these prefabricated components, the individual strip conductors are arranged in the desired stack geometry and the stack thus formed is connected to form a mechanically stable prefabricated component by an adhesive or a potting agent. It is thus possible to form in particular mechanically inherently stable cuboidal magnet elements, which are then embedded as a whole into associated cutouts in the rotor support.

However, the use of such prefabricated components has the disadvantage that there is a not inconsiderable layer of adhesive or potting agent in the region of the outer surfaces that makes it more difficult to thermally couple the superconducting strip conductors of the stack to the rotor support. If the prefabricated component is to satisfy predefined geometric dimensions, it is expedient to compensate slight variations in the spatial position of the individual strip conductors of the stack by way of an enclosing adhesive or potting agent. In addition, the adhesive or potting agent may provide the mechanical strength of the prefabricated component. Consequently, the layer thickness of this external material is not inconsiderable and may be in the range of 1 mm or more. The thermal conductivity of certain adhesives or potting agents is relatively low in comparison with metallic materials, and therefore such an enclosing and/or compensating layer may make it more difficult to thermally couple the individual superconducting strip conductors. When inserting such a prefabricated component into a matching cutout in the rotor support, a small gap is furthermore formed between the component and the rotor support. If this gap remains empty, there is a particularly poor thermal coupling to the surrounding rotor support in this region. Even if the gap is filled with an additional filler, the overall result is an undesirably high layer thickness of additional material between the strip conductors and the material of the rotor support.

### SUMMARY AND DESCRIPTION

One object of the disclosure is therefore to specify a rotor which overcomes the disadvantages mentioned. In particular, the objective is to provide a rotor which is comparatively easy to produce and in which there is a good thermal connection of the strip conductors of the strip conductor stack that are used to the rotor support. A further object is to specify an electrical machine having such a rotor. In addition, the objective is to provide a method for producing such a rotor.

These objects are achieved by the rotor, the electrical machine, and the method described herein. The scope of the present disclosure is defined solely by the appended claims and is not affected to any degree by the statements within this summary. The present embodiments may obviate one or more of the drawbacks or limitations in the related art.

The rotor is configured as a rotor for an electrical machine. The rotor has a central rotor axis A. The rotor includes a rotor support and a superconducting permanent magnet device which is mechanically supported by the rotor support and has one or more superconducting magnet elements. In this respect, the respective superconducting magnet element is embedded in a matching, assigned radially external cutout of the rotor support. The respective superconducting magnet element is formed by at least one stack composed of a plurality of superconducting strip conductors. The respective strip conductor stack is fixed in the associated cutout by a pole cap arranged radially further to the outside, in such a way that the pole cap holds the individual strip conductors together in the stack.

In the present context, a superconducting permanent magnet element refers to an element which includes a superconductor material and which may be brought into a permanently magnetized state by being magnetized at a cryogenic temperature and maintaining this cryogenic temperature. The rotor may include a plurality of such superconducting magnet elements in order to be able to generate a multi-pole magnetic field. These magnet elements may be distributed over the circumference of the rotor such that (either individually or in groups) they correspond to the individual magnetic poles of a permanently excited rotor.

The individual strip conductors of the strip conductor stack are, in particular, stacked one on top of the other in the radial direction. In this way, a strip conductor stack may be formed in a particularly simple manner by sequentially inserting individual strip conductors into the radially external cutout.

A substantial advantage of the rotor is that the strip conductor stack is present here not as a prefabricated component, but only as a stack formed in situ. Expressed differently, the intention is that here in particular the strip conductor stack has been formed only within the associated cutout of the rotor support. In any case, the strip conductor stack does not form a mechanically inherently stable prefabricated component. It is thus the case in particular that the individual strip conductors have not been connected to one another by an adhesive or potting agent to form a prefabricated component already before being inserted into the cutout.

In particular, the individual strip conductors of the strip conductor stack may also be stacked loosely one on top of the other in the rotor as a finished product. In this variant, it may easily be seen that a prefabricated component in the sense of a mechanically inherently stable stack composite assembly is not present. In principle, the individual strip conductors of the strip conductor stack may, however, also have been connected to one another after this (e.g., after being inserted into the cutout of the rotor support). Such a subsequent connection may be effected, for example, by filling the existing gaps with an adhesive and/or with a potting agent. The fact that this connection is only produced afterwards and was not formed already in a prefabricated magnet element as in the prior art may easily be recognized by there not being any gap between the strip conductor stack and the surrounding regions of the rotor support in such a case. This is because such a gap is completely filled when the adhesive or potting agent is subsequently introduced.

In the case of the strip conductor stack that is formed only in situ within the cutout, the individual strip conductors of the stack are fixed by the pole cap. If the individual strip conductors even in the finished rotor lie only loosely one above the other, the individual strip conductors are held together in the radial direction substantially only by the pole cap. However, if the individual strip conductors have additionally been connected to one another in the finished rotor by a subsequently introduced adhesive or potting agent, the pole cap provides the initial fixation before such an adhesive or potting agent is introduced into the cutout and in that case additionally fixes the stack. In this case, the stack is fixed by the pole cap while the potting agent or adhesive is hardening. It is common to all variants that the pole cap is pressed with a contact pressure from radially outside against the strip conductor stack and thus fixes the individual strip conductors with respect to one another.

Associated with the described design of the strip conductor stack as a strip conductor stack which is not prefabricated but is formed only in situ are two significant advantages. In one advantage, the production of the rotor is improved in that fewer method acts and also fewer special manufacturing devices are required and the production as a whole is simplified. If the strip conductor stack is formed only within the associated cutout, a separate device for producing the prefabricated magnet elements is not required. A further advantage is that an optionally present layer that encloses or laterally delimits the strip conductor stack (e.g., a layer between the strip conductor stack and the surrounding parts of the rotor support) may be formed as significantly thinner overall than in the case of corresponding prefabricated components. With such a thin configuration of the enclosing layer, a significantly improved thermal connection of the individual strip conductors to the rotor support may be achieved.

The electrical machine has a rotor and a stator that is arranged in a fixed manner. The advantages of the machine are obtained in a manner similar to the described advantages of the rotor.

The method is used to produce a rotor. The method includes forming at least one strip conductor stack by sequentially introducing a plurality of superconducting strip conductors into a matching, radially external cutout of the rotor support. The method further includes subsequently mechanically fixing the strip conductor stack formed in this way by a pole cap arranged radially further to the outside.

Expressed differently, the strip conductor stack is formed only in situ within the cutout and is not present as a prefabricated component. The pole cap arranged radially on the outside is attached only after this, that is to say only after the formation of the strip conductor stack. This allows a mechanical fixation of the strip conductor stack formed in situ. The advantages of the method and also the advantageous embodiments are obtained in a manner similar to the described advantages and embodiments of the rotor. In particular, it is also possible for a plurality of such stacks to be formed within one or more matching cutouts, as a result of which then in the latter case a plurality of superconducting magnet elements are produced. A plurality of stacks may thus also be formed next to one another within a given cutout. In the present context, the term “matching” may thus mean that the size and shape of the cutout may match either exactly one stack or a plurality of stacks lying next to one another in the cutout.

Here, the described configurations of the rotor, of the electrical machine and of the production method may be advantageously combined with one another.

Thus, according to an advantageous embodiment, it is possible for the individual superconducting strip conductors in the at least one strip conductor stack to lie loosely one on top of the other. In this embodiment, the individual superconducting strip conductors may not be connected to one another to form a mechanically strong unit, or may not be encapsulated or adhesively bonded. In this embodiment, the individual strip conductors may be displaced with respect to one another in a lateral direction, wherein the lateral direction is a direction perpendicular to the stacking direction and parallel to the plane of the strip conductor. Such a lateral displaceability is in any case not prevented by a mechanically strong connection of the individual strip conductors. If there is enough space for such a movement laterally next to the strip conductors, a lateral displacement is possible with this variant. In this embodiment, the production of the strip conductor stack is particularly easy, because no additional act at all is required for the production of a fixed strip conductor composite assembly. The individual strip conductors are fixed with respect to one another merely by virtue of the pole cap pressed on from the outside. This embodiment is particularly advantageous in combination with filling the cavities formed with a heat-conducting grease. Such a heat-conducting grease is present as a highly viscous liquid at least at room temperature and does not form a mechanically strong bond between the strip conductors. The heat-conducting grease, however, advantageously brings about a good thermal coupling of the individual strip conductors to the rotor support.

According to an alternative embodiment variant, the individual superconducting strip conductors of the at least one strip conductor stack may be connected to one another within the associated cutout by adhesive bonding and/or encapsulation. The adhesive bonding or encapsulation is then carried out in particular subsequently, e.g., only after the stack has been inserted into the cutout. This first subsequent formation of the fixed connection between the individual strip conductors may easily be recognized in that the adhesive or the potting agent fills the intermediate space between the strip conductor stack and the delimiting walls of the cutout without a gap. In the case of a prefabricated adhesively bonded or encapsulated magnet element, by contrast, a residual gap would remain between the adhesive or the potting agent and the boundaries of the cutout. This residual gap, which is present in a rotor according to the prior art, may be filled with a further filler in order to further improve the thermal coupling. This additional act is omitted in the described embodiment of the rotor, as a result of which the production process as a whole is simplified.

The described encapsulation of the strip conductor stack within the cutout may be understood to mean filling the existing cavities with a suitable potting agent. In principle, the suitable potting agent may be either an organic or an inorganic potting agent. According to one advantageous embodiment, the potting agent may be a metallic solder material with a low melting point. A significant advantage of such a metallic solder material is that it has a considerably higher thermal conductivity in comparison with most organic materials. A better thermal coupling of the strip conductor stack to the rotor support may thus be achieved. Moreover, the coefficient of thermal expansion of metallic solder materials may be lower than that of exemplary organic potting agents.

In the present context, a potting agent may be understood to mean a potting agent which has been introduced into the remaining intermediate spaces after the formation of the strip conductor stack. By contrast, an adhesive or some other filler may also be introduced into the resulting lateral cavities already during the formation of the stack and, if appropriate, also into the intermediate spaces between the individual strip conductors which lie one on top of the other.

Irrespective of the material of the pole cap, the pole cap may be formed such that it at least covers the strip conductor stack both in the axial and in the azimuthal direction. The pole cap may thus be at least as wide as the strip conductor stack in the directions mentioned. The pole cap may particularly advantageously protrude beyond the strip conductor stack at least in the azimuthal direction in order to achieve a particularly reliable mechanical fixation. Such a pole cap may have a cross-sectional shape with a rounded radially external surface and a protrusion on either side (e.g., beyond the lateral dimension of the magnet element) in the circumferential direction.

Irrespective of the other configuration of the individual magnet elements, according to a first advantageous embodiment, the pole cap may be formed from a non-magnetic material. In this embodiment, there is thus no magnetic interaction between the superconducting magnet element and the pole cap. Rather, the pole cap substantially serves to mechanically fix the strip conductor stack.

According to an alternative advantageous embodiment, the pole cap may include a ferromagnetic material. In particular, it may be formed substantially from a ferromagnetic material. Such a ferromagnetic pole cap may contribute to an improvement of the magnetic flux guidance of the excitation field formed. In particular, such a ferromagnetic pole cap may contribute to a homogenization of the magnetic flux. This may be particularly advantageous primarily when a magnet element is formed from a plurality of strip conductor stacks which lie (e.g., axially and/or azimuthally) next to one another. In such a case, the strip conductor stacks lying next to one another may form a relatively inhomogeneous magnetic field which has individual maxima of the magnetic flux density above those of the individual sub-stacks. For most applications, however, a considerably more homogeneous flow distribution is desired, in which these sharp maxima may be smoothed. Such smoothing may advantageously be achieved by a ferromagnetic pole cap which jointly covers the sub-stacks lying next to one another.

Advantageous ferromagnetic materials for the pole cap are, for example, iron and iron-containing alloys and compounds, (e.g., soft iron, ferrite, St37, transformer sheet, dynamo sheet, cobalt-iron, silicon-iron, nickel-iron, and also the alloy X8Ni9). Advantageously, the ferromagnetic material has a comparatively high saturation magnetization, (e.g., a saturation magnetization in the range of 1.0 Tesla and 2.5 Tesla, or in the range of 1.5 Tesla and 2.5 Tesla).

In an advantageous variant of the ferromagnetic pole cap, it is formed as thinner in its azimuthal edge regions and extends radially outwardly to a lesser extent there than in its azimuthal center. It is advantageously possible for a shaping of this kind to achieve the situation in which, as viewed in the circumferential direction of the rotor, a substantially sinusoidal magnetic flux profile is created. The use of such a rotor in an electrical machine allows a comparatively low-harmonic operation.

The superconducting permanent magnet device may be configured to generate a magnetic field with a magnetic flux density of at least 1 Tesla. In some examples, the magnetic flux density may be even above 1.5 T. For example, the flux density mentioned may be a flux density within the rotor. Particularly advantageously, however, the magnetic flux density in the air gap of the electrical machine is also in this comparatively high range. One advantage of this embodiment is that the magnetic flux density may be higher than it would be possible to achieve with conventional permanent magnets. With such high magnetic flux densities, the advantages described are particularly effective in guiding the magnetic flux by ferromagnetic pole caps.

Advantageously, the superconducting magnet element may be composed of a plurality of strip conductor stacks arranged next to one another. In embodiments in which the rotor includes a plurality of magnet elements, it is possible for each of these magnet elements to be segmented in the manner described. The stacking direction of the strip conductor stack may advantageously be a radial direction with respect to the central rotor axis A. In this case, the individual stacks lying next to one another may be arranged lying axially and/or azimuthally next to one another. A segmentation of this kind allows magnet elements with relatively large spatial dimensions to be formed in a simple manner.

With the described segmentation into a plurality of strip conductor stacks lying next to one another, they may be arranged either in respective separate assigned cutouts or a plurality of strip conductor stacks may in each case be arranged next to one another in a common recess. The separate arrangement of individual strip conductor stacks in individual cutouts may be advantageous in order to improve the thermal coupling of the respective strip conductor stack to the material of the rotor support. The joint embedding of a plurality of stacks that lie next to one another into a superordinate cutout may, however, be advantageous in order to achieve a configuration of a superordinate magnetic pole that is without gaps to the greatest possible extent or has as few gaps as possible. In particular, a comparatively high and homogeneous magnetic flux density may be achieved by a plurality of strip conductor stacks which lie very closely next to one another.

If a plurality of strip conductor stacks which lie next to one another together form a magnetic pole, it may be advantageous to fix these individual sub-stacks by a common pole cap. In this case, for example, either exactly one pole cap may be used for each magnetic pole or, if appropriate, there may also be a plurality of sub-caps for a magnetic pole. When using magnetic flux-guiding pole caps, a homogenization of the magnetic flux density may be achieved as described above in this case.

As an alternative to the discrete sub-stacks lying next to one another that have been described, it is also possible and under certain circumstances advantageous to form a strip conductor stack which has a plurality of strip conductors lying next to one another in each level of the stack, the strip conductors of the adjacent stack levels, however, being arranged geometrically offset from one another in such a way that different positions of the gaps result from level to level. Homogenization of the magnetic flux density by flux-guiding ferromagnetic pole caps is also advantageous in the case of such more complex stacks.

According to an advantageous embodiment, a respective intermediate space which is filled with a filler may be formed between the strip conductor stack and the walls of the associated cutout. In particular, such an intermediate space is substantially completely filled with this filler. As described further above, such a filler is introduced in particular after this, that is to say after the conductor stack has been formed within the cutout, into the cavity formed during the stacking. By filling the cavities, the thermal coupling of the individual strip conductors to the rotor support is advantageously improved. Optionally, such a filler may additionally also fill existing intermediate spaces between the individual strip conductors of the stack and thus better thermally couple the individual strip conductors to one another.

Such a filler may be a heat-conducting grease, an epoxy resin, a paraffin, a solder material with a low melting point, or a combination thereof. The filler may thus be either a filler which is liquid (if appropriate, highly viscous) at room temperature or a filler which is solid at room temperature. Such a solid filler may be obtained, for example, by hardening an adhesive or a potting agent or by solidifying a solder material with a low melting point. The starting material for such a solid filler may thus also be a liquid filler material. A liquid starting material may be provided (irrespective of the later state of aggregation of the filler), because the liquid starting material may also be used to achieve an extensive filling even of smaller cavities and, in particular, narrow gaps.

A particularly suitable heat-conducting grease may be Apiezon N, because it has a high thermal conductivity and moreover may be readily processed. Both unfilled epoxy resins (for example, Stycast 1266) and filled epoxy resins (for example, Stycast 2850 FT) are suitable as epoxy resins. The epoxy resins may be of the Stycast type. Solder materials with a melting point below 250° C., (e.g., with a melting point in a range of 30° C. and 200° C.), are particularly suitable as solder materials with a low melting point. Solders with a low melting point of this kind are particularly suitable for forming a mechanically strong and thermally highly conductive filling of the intermediate spaces, excessive thermal loading of the sensitive strip conductors being advantageously avoided. Particularly suitable solders with a low melting point are, for example, indium-containing solders, in particular what is known as Field's metal.

Advantageously, the filler may have a specific thermal conductivity of at least 0.05 W/m·K. The stated value for the thermal conductivity may apply here, in particular, at an operating temperature of the rotor. This operating temperature may be a cryogenic operating temperature at which the superconducting material of the strip conductor is in the superconducting state. For example, such a cryogenic operating temperature may be in a range between 20 K and 30 K. With epoxy resins as fillers, at such cryogenic temperatures it is possible to achieve thermal conductivities above 0.07 W/m·K, for example. With heat-conducting greases, even higher values may advantageously be achieved, for example, thermal conductivities above 0.12 W/m·K. With solders with a low melting point, still considerably higher values may advantageously be achieved, for example, thermal conductivities above 10 W/m·K.

Advantageously, the filler may have a maximum layer thickness of at most 0.5 mm and in particular at most 0.2 mm in an intermediate space between the strip conductor stack and the walls of the associated cutout. In this case, the layer in this intermediate space that is formed by the filler may not be a particularly homogeneous layer, because the individual strip conductors of the stack may be arranged laterally somewhat offset in relation to one another from layer to layer, e.g., in the case of the in-situ formation of the stack described. This brings about a considerable variation in the respective thickness of the intermediate space which is to be filled with the filler. The average layer thickness of the filler in this intermediate space may thus in particular be considerably lower than the maximum values mentioned above. However, it may also be in a similar range. For example, such an average layer thickness may (and irrespective of the respectively existing maximum layer thickness) advantageously be in the range of 0.05 mm and 0.5 mm, or in the range of 0.05 mm and 0.2 mm.

The comparatively small layer thicknesses described are particularly advantageous if the filler is an organic filler and has a rather low thermal conductivity (for example, below 1 W/m·K). In these embodiments, it is particularly desirable if the filler layer surrounding the strip conductor stack is particularly thin, because then a comparatively good thermal connection of the strip conductor stack to the rotor support may nevertheless be provided. In other embodiments with fillers with a higher thermal conductivity (for example, above 1 W/m·K) and in particular when using metallic solders with a low melting point, considerably greater layer thicknesses of the surrounding filler may expediently also be advantageous, for example, layer thicknesses in the range of 0.1 mm and 1 mm. Due to the high specific thermal conductivity of these materials, a comparatively good thermal connection is nevertheless possible in that case.

It is possible for the individual strip conductors of the at least one strip conductor stack to each be in the form of a high-temperature superconducting strip conductor. In particular, they may each have a normally conducting substrate and a high-temperature superconducting layer. High-temperature superconductors (HTS) are superconducting materials with a transition temperature above 25 K and in the case of some material classes above 77 K, where the operating temperature may be reached by cooling with other cryogenic materials than liquid helium. Therefore, HTS materials are also particularly attractive because these materials may have high upper critical magnetic fields and high critical current densities, depending on the choice of operating temperature. The high-temperature superconductor may include magnesium diboride or a ceramic oxide superconductor, for example, a compound of the type REBa₂Cu₃Oₓ (abbreviation: REBCO), where RE is a rare-earth element or a mixture of such elements.

The rotor support may be formed such that it is at a cryogenic operating temperature when the rotor is in operation. In this way, the situation may be achieved in which the superconducting magnet elements may be cooled by way of the rotor support. As an alternative or in addition, the superconducting magnet elements may be coupled directly to additional elements of a cooling bus. For example, individual copper elements of a copper cooling bus may be embedded in addition in the described cutouts in the rotor support, with the result that the embedded magnet elements may come into direct contact with these copper elements. As an alternative, it is also possible for one or more heat pipes to be integrated in the rotor support, with the result that the strip conductor stacks may come into thermal contact with the ends of these heat pipes in the region of the cutouts.

The rotor support may be formed from a non-magnetic material. This is advantageous in order to avoid closing the magnetic flux path in the rotor support and to generate a high magnetic flux density in areas which are radially further to the outside. Suitable materials for the rotor support are, for example, non-magnetic stainless steel, aluminum, aluminum-containing alloys, copper, and copper-containing alloys such as brass.

The mechanical pressing on of the pole caps described may be achieved, for example, by screwing, by clamping, and/or by axially pushing pole caps in the form of a dovetail into matching cutouts.

The width of the individual strip conductors of the strip conductor stack may, for example, be in a range of 4 mm and 100 mm. In this case, comparatively wide strip conductors may be provided in order to form superconducting magnet elements which are as large as possible and have relatively homogeneous magnetic fields and a high degree of magnetization.

### BRIEF DESCRIPTION OF THE DRAWINGS

The disclosure will be described below using a number of exemplary embodiments with reference to the appended drawings, in which:

FIG. 1 depicts a schematic cross section through a first embodiment of an electrical machine.

FIGS. 2 to 5 depict details of similar exemplary machines in the field of superconducting magnet elements.

FIG. 6 depicts a schematic cross section through a further embodiment of an electrical machine.

In the figures, elements that are the same or have the same function are provided with the same reference signs.

### DETAILED DESCRIPTION

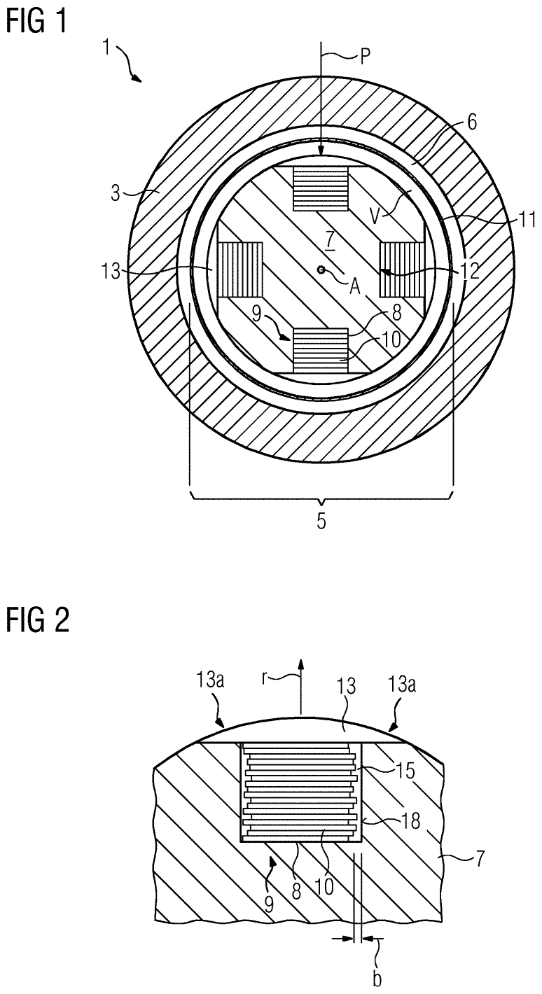

FIG. 1 depicts a schematic cross section of an electrical machine 1, that is to say shows the electrical machine perpendicularly to the central axis A. The machine includes an external stationary stator 3 and an internal rotor 5 which is rotatably mounted about the central axis A. The electromagnetic interaction between the rotor 5 and the stator 3 takes place across the air gap 6 situated between them. What is involved is a permanently excited machine which has a plurality of superconducting permanent magnet elements 9 for the purpose of forming an excitation field in the region of the rotor. In the cross section of FIG. 1, here by way of example four permanent magnets of this type are distributed over the circumference of the rotor. The permanent magnets are arranged in corresponding radially external cutouts 12 of a rotor support 7, the rotor support 7 mechanically supporting the magnet elements 9. However, further magnet elements than the four shown here may also be present in the axial direction, not shown here, wherein however the number of magnetic poles of the electrical machine is not increased by such an axial subdivision.

The rotor support 7, together with the magnet elements 9 held thereon, is cooled to a cryogenic operating temperature, which is below the transition temperature of the superconductor material used in the magnet elements, by a cooling apparatus, not shown in any more detail here. In order to maintain this cryogenic temperature, the rotor support 7 and magnet elements 9 are arranged together in the interior of a cryostat 11. There is an annular vacuum space V for thermal insulation between the cryostat and the rotor support 7.

In the exemplary embodiment in FIG. 1, the individual magnet elements 9 are each in the form of a strip conductor stack 8 composed of individual superconducting strip conductors 10. In this case, a respective plurality of such superconducting strip conductors 10 are stacked one on top of the other in a radial direction. The individual strip conductors 10 of the respective strip conductor stacks are not connected to one another to form a prefabricated component here, but rather they have been inserted one after the other into the corresponding cutout 12 of the rotor support 7. The strip conductor stacks 8 were thus formed here in situ within the respective cutouts 12 of the rotor support 7. The strip conductor stacks 8 formed in this way were then each mechanically fixed by the arrangement of a pole cap 13 which is radially further to the outside. These pole caps 13 thus hold the individual strip conductors 10 of the strip conductor stacks formed in the cutouts together. For this purpose, the pole caps 13 are pressed with a radial contact pressure p from radially outside against the strip conductor stacks 8. After the strip conductor stacks have been formed, the individual strip conductors 10 are initially not fixedly connected to one another. It is possible that they lie only loosely one above the other in the finished rotor 5 and are held together only by the contact pressure p of the pole caps 13. As an alternative, however, after the stack has been formed, they may be additionally fixed to one another within the respective cutout 12, for example by an adhesive and/or a filler. These different variants will become clear in connection with the details described below.

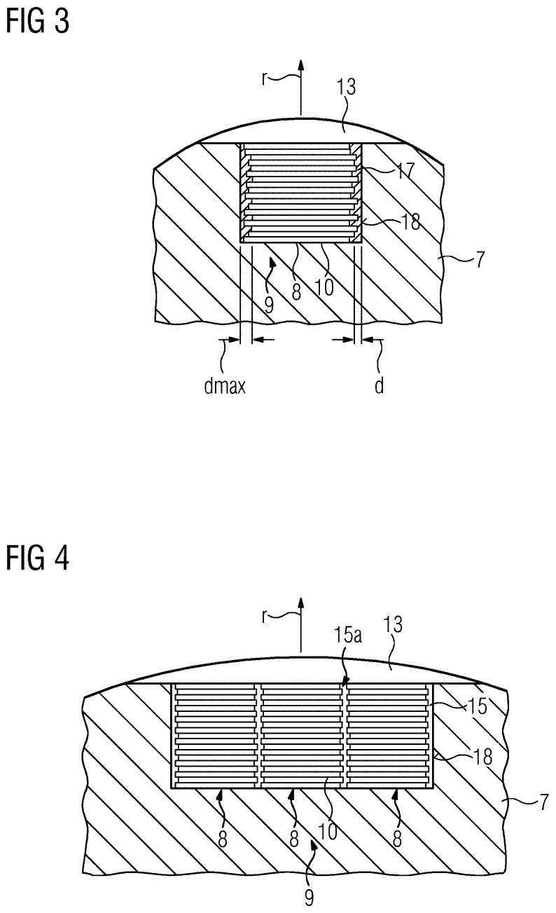

Thus, FIG. 2 depicts a schematic cross section through a detail of the rotor of an electrical machine. The figure shows the region of a superconducting magnet element 9 which is embedded in a radially external cutout of the rotor support 7. The remaining part of the electrical machine may be configured, for example, similarly to the example of FIG. 1. The magnet element 9 is also formed here by a strip conductor stack 8 composed of a multiplicity of individual superconducting strip conductors 10. These individual strip conductors 10 are stacked one on top of the other in the radial direction r. They are fixed from radially outside by a pole cap 13, which is pressed with a contact pressure against the strip conductor stack 8. The means for forming this contact pressure are not shown here for the sake of clarity. In the example of FIG. 2, the individual strip conductors 10 of the strip conductor stack 8 are only loosely placed one on top of the other and are held together exclusively by the pressing on of the external pole cap 13. Otherwise, in principle, they may be displaced with respect to one another in the lateral direction. In particular, they are thus not adhesively bonded to one another or encapsulated together. Because the strip conductor stack has been formed here within the cutout by sequentially inserting the individual strip conductors 10, the strip conductors 10 may have a slight lateral offset in relation to one another. This lateral offset is shown in an exaggerated manner in FIG. 2 for the sake of clarity. A small intermediate space 15 is formed between the lateral edges of the individual strip conductors and the walls 18 of the associated cutout in the rotor support. This intermediate space 15 is also shown in an exaggerated manner here. The intermediate space may also be only a minimum gap that remains toward the walls of the cutout after the strip conductor has been inserted, some strip conductors also being able to touch the wall directly. The average width of this intermediate space or gap is denoted by b in FIG. 2. In comparison with a conventional prefabricated strip conductor stack, this average spacing b to the walls of the cutout may be selected to be particularly small. This is due to the fact that the strip conductor stack formed in situ does not require any outer enclosure to mechanically fix the individual strip conductors to one another and that, in comparison with the prefabricated component, a precise matching to the size of the cutout may achieve a particularly small lateral offset of the individual strip conductors.

The radially external pole caps 13 are shaped such that they reproduce or continue the circular outer cross-sectional shape of the rotor support in the azimuthal direction. Here, the individual pole caps 13 are each formed from a ferromagnetic material. This may advantageously bring about improved magnetic flux guidance and, in particular, homogenization of the magnetic flux penetrating radially outward.

FIG. 3 depicts a detail for a similar region of a rotor according to a further example. Also shown here is the region of a superconducting magnet element 8, which as a whole is formed in a manner similar to the example in FIG. 2. In contrast to the example in FIG. 2, the intermediate space between the lateral edges of the strip conductors and the walls 18 of the cutout is filled with a filler 17. This filler 17 may advantageously substantially completely or at least predominantly fill the lateral intermediate space. In principle, it may be either a filler which is liquid (if appropriate, highly viscously liquid) at room temperature or else a filler which is solid at room temperature. A solid filler may be obtained, for example, by pouring an originally liquid filler into the intermediate space and then chemically hardening it or solidifying it by cooling. Here, the filler may be introduced into the lateral intermediate space either subsequently after the arrangement of the entire strip conductor stack and/or during the stacking of the individual strip conductors. For example, the filler may be a heat-conducting grease, an adhesive, a potting agent, a solder with a low melting point, or a combination thereof.

A significant advantage of filling the intermediate space with such a filler 17 is that the thermal coupling of the strip conductor stack 8 to the rotor support 7 may be significantly improved in comparison with an unfilled intermediate space. This is the case in particular if the thermal conductivity of the filler 17 is comparatively high and/or if the average layer thickness d of the laterally enclosing filler 17 is selected to be comparatively small. For example, this average layer thickness may be below 0.5 mm. This average layer thickness may advantageously be chosen as considerably thinner than would be possible when using a prefabricated, already adhesively bonded or potted strip conductor stack.

It is also the case in the example of FIG. 3 that the individual strip conductors 10 of the strip conductor stack 8 have a mutual slight lateral offset, which is also shown in an exaggerated manner here. As a result of this lateral offset, the layer thickness d of the laterally adjacent filler 17 is not constant, but may vary considerably from position to position. If individual strip conductors touch the lateral wall 18, the lateral thickness may also be 0 or almost 0 at individual points. The maximum lateral layer thickness of the filler 17 is denoted by dₘₐₓ in FIG. 3. It may also advantageously be considerably less than in the case of a comparable prefabricated and already adhesively bonded or potted magnet element.

FIG. 4 depicts a similar detail of a rotor according to a further example. In contrast to the preceding examples, the magnet element 9 is not formed here by an individual strip conductor stack, but rather by a plurality of strip conductor stacks 8 arranged next to one another. Three strip conductor stacks 8 lying next to one another are shown here by way of example, it also being possible for this number to be chosen as lower or higher. In the example in FIG. 4, the individual strip conductor stacks are arranged next to one another in the azimuthal direction of the rotor. They are embedded together in a common cutout in the rotor support 7. Moreover, they are fixed together by a common pole cap 13 which projects beyond all three strip conductor stacks 8 of the magnet element 9 in the azimuthal direction. It is also the case here that the pole cap is selected from a ferromagnetic flux-guiding material. With the segmentation of the magnet element 9 that is present here, this selection is particularly expedient to achieve a homogenization of the magnetic flux which advances radially outward. In particular, this outwardly smooths the maxima of the magnetic flux that are formed over the individual strip conductor stacks 18.

In the example in FIG. 4, it is also fundamentally conceivable that the intermediate spaces 15 between the strip conductor stacks 8 and the walls of the cutout either remain free or are filled with a filler similar to the example of FIG. 3. The intermediate spaces 15a, which are formed between the individual strip conductor stacks 8, may also similarly either remain free or be filled with a filler. The use of a filler may be advantageous in order to improve the thermal coupling and thus the cooling of the individual strip conductor stacks.

FIG. 5 depicts a further detail of a rotor according to a further exemplary embodiment. The figure shows a plan view from radially outside onto a radially external surface of the rotor in the region of three external cutouts. These three cutouts are arranged next to one another in the axial direction of the rotor here. Three associated strip conductor stacks 8 are embedded in these three cutouts, e.g., one strip conductor stack in each case per cutout. These axially adjacent strip conductor stacks in particular together form a common magnetic pole of the rotor.

In the example of FIG. 5, only one respective strip conductor stack 8 is embedded in each of the cutouts. However, it is alternatively also possible for a magnet element 9 to be embedded in each of these cutouts, which magnet element, similar to the example in FIG. 4, is formed from a plurality of azimuthally adjacent strip conductor stacks. According to a further embodiment, it is also possible that, as an alternative or in addition, a plurality of axially adjacent strip conductor stacks are also arranged together in a common cutout in the rotor support.

It is also the case in the example in FIG. 5, similar to the example in FIG. 3, that the intermediate spaces between the strip conductor stacks and the lateral walls of the cutouts are filled with a filler 17 having a correspondingly low average layer thickness d. In principle, however, it is also possible for these intermediate spaces to have a relatively small width and to be formed without such a filling, similar to the example in FIG. 2.

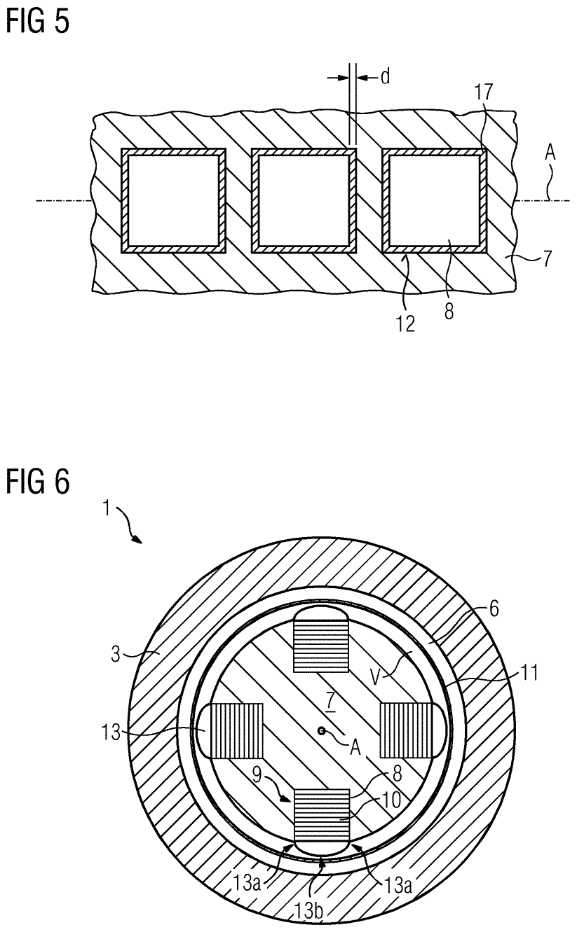

FIG. 6 depicts a schematic cross-sectional illustration for a further embodiment of an electrical machine. Overall, this electrical machine is configured similarly to the electrical machine in FIG. 1. In contrast to this, however, here the pole caps 13 on their radially external side are not reproduced on the circular circumference of the rotor support 7, but rather they have a greater curvature. Similar to the example in FIG. 1, it is thus also the case here that the azimuthal edge regions 13a of the pole caps are each formed as thinner than the azimuthal center 13b. In the example of FIG. 6, however, the azimuthal centers 13b extend in the radial direction outwardly to a still greater extent than these azimuthal edge regions 13a. As a result of this greater curvature, the situation may advantageously be achieved in which the magnetic flux density that is formed has a substantially sinusoidal profile viewed over the circumference of the rotor. This advantageously leads to a low-harmonic electrical machine 1.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

### LIST OF REFERENCE SIGNS

1 Electrical machine
3 Stator
5 Rotor
6 Air gap
7 Rotor support
8 Strip conductor stack
9 Superconducting magnet element
10 Strip conductor
11 Cryostat wall
12 Radially external cutout
13 Pole cap
13a Azimuthal edge region of the pole cap
13b Azimuthal center of the pole cap
15 Intermediate space
15a Intermediate space between strip conductor stacks
17 Filler
18 Wall of the cutout
A Central rotor axis
b Average width of the gap
d Average layer thickness
dₘₐₓ Maximum lateral layer thickness
p Contact pressure
r Radial direction
V Vacuum space

1. A rotor for an electrical machine with a central rotor axis, the rotor comprising:
a rotor support; and
a superconducting permanent magnet device mechanically supported by the rotor support, the superconducting permanent magnet device having one or more superconducting magnet elements,
wherein a superconducting magnet element of the one or more superconducting magnet elements is embedded in a matching, assigned radially external cutout of the rotor support,
wherein the superconducting magnetic element is formed by at least one strip conductor stack composed of a plurality of superconducting strip conductors, and
wherein the respective strip conductor stack is fixed in an associated cutout by a pole cap arranged radially further to the outside such that the pole cap holds individual superconducting strip conductors of the plurality of superconducting strip conductors together in the strip conductor stack.

2. The rotor of claim 1, wherein the individual superconducting strip conductors of the at least one strip conductor stack lie loosely above one another.

3. The rotor of claim 1, wherein the individual superconducting strip conductors of the at least one strip conductor stack are connected to one another within the associated cutout by adhesive bonding and/or encapsulation.

4. The rotor of claim 1, wherein the pole cap comprises a non-magnetic material.

5. The rotor of claim 1, wherein the pole cap comprises a ferromagnetic material.

6. The rotor of claim 5, wherein the pole cap thinner in azimuthal edge regions of the pole cap, and
wherein the pole cap extends radially outwardly to a lesser extent than in an azimuthal center of the pole cap.

7. The rotor of claim 1, wherein the superconducting permanent magnet device is configured to generate a magnetic field with a magnetic flux density of at least 1.0 T.

8. The rotor of claim 1, wherein the at least one strip conductor stack comprises a plurality of strip conductor stacks arranged next to one another.

9. The rotor of claim 1, wherein an intermediate space comprising a filler is positioned between the strip conductor stack and walls of the associated cutout.

10. The rotor of claim 9, wherein the filler is a heat-conducting grease, an epoxy resin, a paraffin, a solder material with a low melting point, or a combination thereof.

11. The rotor of claim 10, wherein the filler has a specific thermal conductivity of at least 0.05 W/m·K at an operating temperature of the rotor.

12. The rotor of claim 11, wherein the filler has a maximum layer thickness of at most 0.5 mm in the intermediate space between the strip conductor stack and the walls of the associated cutout.

13. The rotor of claim 1, wherein the individual strip conductors of the at least one strip conductor stack each have a normally conducting substrate and a high-temperature superconducting layer.

14. An electrical machine comprising:
a stator that is arranged in a fixed manner; and
a rotor, wherein the rotor comprises:
a rotor support; and
a superconducting permanent magnet device mechanically supported by the rotor support, the superconducting permanent magnet device having one or more superconducting magnet elements,
wherein a superconducting magnet element of the one or more superconducting magnet elements is embedded in a matching, assigned radially external cutout of the rotor support,
wherein the superconducting magnetic element is formed by at least one strip conductor stack composed of a plurality of superconducting strip conductors, and
wherein the respective strip conductor stack is fixed in an associated cutout by a pole cap arranged radially further to the outside such that the pole cap holds individual superconducting strip conductors of the plurality of superconducting strip conductors together in the strip conductor stack.

15. A method for producing a rotor, the method comprising:
providing a rotor support; and
forming a superconducting permanent magnet device having a superconducting magnet element, wherein the superconducting magnetic element is formed by a strip conductor stack by sequentially introducing a plurality of superconducting strip conductors into a matching, radially external cutout of the rotor support, and subsequently mechanically fixing the strip conductor stack formed by a pole cap arranged radially further to the outside.

16. The rotor of claim 9, wherein the filler has a specific thermal conductivity of at least 0.05 W/m·K at an operating temperature of the rotor.

17. The rotor of claim 9, wherein the filler has a maximum layer thickness of at most 0.5 mm in the intermediate space between the strip conductor stack and the walls of the associated cutout.

18. The rotor of claim 9, wherein the filler has a maximum layer thickness of at most 0.2 mm in the intermediate space between the strip conductor stack and the walls of the associated cutout.
